(19) United States
(12) Patent Application Publication
(10) Pub. No.: US 2008/0028040 A1
(43) Pub. Date: Jan. 31, 2008

(54) METHOD AND APPARATUS FOR LOCATION DEPENDENT SOFTWARE APPLICATIONS

(76) Inventors: Gary Tremblay, Nepean (CA); Pierre Veilleux, Cumberland (CA); Danny St-Denis, Windsor (CA)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/870,605

(22) Filed: Oct. 11, 2007

Related U.S. Application Data
(63) Continuation of application No. 10/408,759, filed on Apr. 7, 2003.

(30) Foreign Application Priority Data
Apr. 5, 2002 (CA) 2,380,702

(51) Int. Cl. G06F 15/16

(52) U.S. Cl. 709/218

(57) ABSTRACT

A method of content distribution over a communication network comprising the steps of: an End User sending a request to an Internet Service Provider (ISP) to access content from a Web site, via a local network interconnecting said End User to said ISP; said ISP forwarding said request to a Web Server maintaining said Web site; and said Web Server: obtaining information regarding said local network; and tailoring a response in view of said information.

### CROSS REFERENCE TO RELATED APPLICATIONS

This application is a continuation of U.S. patent application Ser. No. 10/408,759 filed Apr. 7, 2003.

### FIELD OF THE INVENTION

The present invention relates generally to computers and communications, and more specifically, to a method and system of implementing location dependent software applications over computer networks.

### BACKGROUND OF THE INVENTION

It is well known that data communication networks such as the Internet, Wide Area Networks (WANs) and Local Area Networks (LANs), offer tremendously efficient means of organizing and distributing computerized data. These efficiencies have resulted in their widespread use for both business and personal applications. For example, the Internet is now a common medium for operating online auctions, academic and public forums, distributing publications such as newspapers and magazines, and performing electronic commerce and electronic mail transactions.

An exemplary layout of an Internet communications system 30 is presented in FIG. 1. Though this a simplified representation, it provides a framework for the balance of this discussion. The Internet 32 itself is represented by a number of routers 34 interconnected by an Internet backbone 36 network designed for high-speed transport of large amounts of data. User's computers 38 may access the Internet 32 in a number of manners including modulating and demodulating data over a telephone line using audio frequencies, which requires a modem 40 and connection to the Public Switched Telephone Network 42, which in turn connects to the Internet 32 via an Internet Service Provider 44. Another manner of connection is the use of set top boxes 50 which modulate and demodulate data onto high frequencies which pass over existing telephone or television cable networks 52 and are connected directly to the Internet via Hi-Speed Internet Service Provider 54. Generally, these high frequency signals are transmitted outside the frequencies of existing services passing over these telephone or television cable networks 52.

Web sites are maintained on servers 56 also connected to the Internet 32 which provide data content and software applications to the End User's computers 38. Communications between End User's computers 38 and the rest of the system 30 are standardized by means of defined communication protocols.

Internet Service Providers (ISPs) 44, 54 or Internet Access Providers (IAPs), are companies that provide access to the Internet 32. ISPs 44, 54 are considered by some to be distinguished from IAPs in that they also provide content and services to their subscribers, but in the context of this disclosure the distinction is irrelevant. For a monthly fee, ISPs 44, 54 generally provider End Users with the necessary software, user name, password and physical access. Equipped with a telephone line modem 40 or set top box 50, one can then log on to the Internet 32 and browse the World Wide Web, and send and receive e-mail.

FIG. 1 is something of a simplification, as ISPs are often connected to the Internet 32 through Network Access Points (NAPs), rather than directly as shown in FIG. 1. As well, the Internet 32 itself is far more complex than that shown in FIG. 1, consisting of a vast interconnection of computers, servers, routers, computer networks and public telecommunication networks which allows two parties to communicate via whatever entities happen to be interconnected at any particular time. However, these details would be well known to one skilled in the art.

At present the World Wide Web (WWW) and its controlling protocols and algorithms are designed for fault tolerant, distance insensitive transmission of digital data. An End User in New York can download information from Tokyo as quickly and as easily as if the data was coming from Seattle. Costs for data transmission are not distance sensitive and no provision has been made within the existing communication protocols to add geographically important information.

Since the WWW is not constrained by distance the geographic location of End Users and servers is typically only of interest to network planners and communications infrastructure companies. This lack of a geographic imperative has led to what might be considered the ‘shotgun’ effect of marketing and services on the WWW: a search for a product or service is just as likely to identify a provider in a different country as it is to respond with information about a local provider.

Simply put, people are not as mobile as the data on the WWW. Customers traditionally patronize companies conveniently located in the communities in which they live but the WWW has no appreciation for the customer's location or the location of the goods and services on the WWW. The value of the WWW for local marketing and business is lost in the volumes of data provided by the international WWW community. It is therefore not surprising that as a marketing and business tool, the Internet has only seen modest success for globally dominate companies with international presence.

The lack of geographic information about End Users on the Internet also provides a serious problem for regulators. Untold billions of sales tax dollars are lost yearly as End Users misrepresent their location when ordering goods and services on the WWW.

Regulators are also interested in controlling specific activities on the WWW according to regional laws and values. These activities include gambling and distribution of controversial material.

The lack of geographic authentication in the WWW also provides problems for WWW service providers. WWW applications which distribute controversial material or provide gaming for real money are forced to locate off shore in countries which provide little or no regulatory control over the activities. Consequently, people avoid the service entirely even if it is a legal activity in their current, local, jurisdiction.

For the WWW to become an important part of the business community it must include provision for the geographic limitations of the End Users. Once End Users start to see the data they want in the context in which they live, the ability of the WWW to provide business services will expand dramatically.

Thus, there is a clear need for geographic authentication of WWW End Users.

Other Proposals

Prior to today's widespread accessibility to the Internet, geographically-restricted services such as remote gaming and betting had to be implemented in a “hard-wired” manner to ensure participants were located within an acceptable jurisdiction. This required the establishment of complicated and expensive secured virtual private networks (VPN), secure wide area networks (WAN), or private telephone lines. Such techniques are known in the art and will not be described in detail herein.

These hard-wired networks were costly and complex, and could not be easily setup or modified. Therefore, they could not be applied to participants with a casual interest in the regulated activity.

With the pervasiveness of the Internet, a large number of on-line services have emerged. Typically, online gaming services use very weak techniques to verify the location of customers, which may explain why many of these services have located themselves beyond the legal reach of regulators in their main markets. For example, many on-line casinos directed towards the United States market are located in Antigua, Belize and Dominican Republic.

Other online services which sell products, and therefore should be collecting duties and sales taxes, have completely disregarded this obligation.

Some geographically-restricted services simply ask the End User to supply a street address which confirms they are currently in the acceptable jurisdiction. Some services even verify the End User's name, telephone number and address against a database to confirm that they should be allowed to use the service, but such controls can be circumvented simply by the End User entering a valid set of personal data for someone else in the acceptable area. Such approaches are therefore completely ineffective against a determined user.

It has also been proposed that databases be created which will provide geographic locations based on the IP address of the End User. In addition to the cost of creating and maintaining these databases, which would require continuous modification and updating, this approach requires the End User's actual IP address, which raises privacy concerns. Furthermore, many dial up ISPs use Dynamic Host Configuration Protocol (DHCP) which dynamically assigns IP addresses to subscribers when they call up. Therefore, a device can have a different IP address every time it connects to the network, and in some systems, the device's IP address can even change while it is still connected.

DHCP simplifies network administration because the software keeps track of IP addresses rather than requiring an administrator to manage the task. This means that a new computer can be added to the network without the inconvenience of manually assigning it a unique IP address. Because the End User is not associated with a unique IP address, the IP address does not reliably correspond with the geographic location of an End User.

Another approach is to use the existing global positioning system (GPS) to identify the geographic location of End Users. The GPS is a system of 24 satellites for identifying earth locations, launched by the U.S. Department of Defense. By triangulation of signals from three of the satellites, a receiving unit can pinpoint its current location anywhere on earth to within a few meters. However, such systems require the End User to install special, expensive hardware and software. Since the GPS equipment is on the End User's premises and out of control of the regulators, it may be subject to tampering. An End User could, for example, alter the data his GPS equipment provides to indicate that he is residing in any jurisdiction that he wishes.

It has also been proposed that IPv6 be designed to accommodate location information. IPv6 is the next generation IP protocol, which among other things, expands the address space from 32 to 128 bits. Therefore, the address space has sufficient room to include both a backward compatible IP address, as well as geographic data. However, this would require universal agreement or standardization, which has not occurred. As well, IPv6 has not been widely implemented, and will likely require some time to replace the currently pervasive IPv4 legacy hardware and software.

If the above problems could be overcome, geographical locating could be used for far more than simply gaming and betting. For example, any services which a Web site wishes to restrict to End Users in a certain geographic area may be so restricted, including government publications, help lines or counselling services. As well, any content which is of regional interest could be distributed, including local news, stock quotations, weather reports, road conditions and public meetings. The system could also determine which state and national taxes apply to the sale of goods by determining the location of the buyer and seller.

For example, the Internet is an excellent medium for advertising because of the rich formatting, including sound, animation and personal interaction with the End User. As well, the Internet is pervasive in developed countries and the cost of making advertising content available once it is created, is minimal. The hardware and software used to implement the Internet, as well as the content that is carried, all have a cost. In many other media, such as television and radio, the cost to End Users is nominal because advertisers pay for most of the cost of the infrastructure. However, there are no effective ways of managing advertising over the Internet.

As noted above, while the Internet is an international communication network, advertising and much other content has only local value. Hence, in order for advertising to be effective, some efficient manner of targeting advertising to End Users based on their geographical location is required. Like the location determining techniques used in gaming applications, none are effective.

There is therefore a need for a means of determining the geographic location of End Users over the Internet and similar networks, provided with consideration for the problems outlined above.

### SUMMARY OF THE INVENTION

It is therefore an object of the invention to provide a method and system which obviates or mitigates at least one of the disadvantages described above.

One aspect of the invention is broadly defined as a method of content distribution over a communication network comprising the steps of: an End User sending a request to an Internet Service Provider (ISP) to access content from a Web site, via a local network interconnecting said End User to said ISP; said ISP forwarding said request to a Web Server maintaining said Web site; and said Web Server: obtaining information regarding said local network; and tailoring a response in view of said information.

Another aspect of the invention is defined as a communication system comprising: an End User; an Internet Service Provider (ISP); a Web Server; a local network, interconnecting said End User and said ISP; and an Internet network, interconnecting said Web Server and said ISP; said End User being operable to send a request to said ISP to access content from a Web site on said Web Server; said ISP being operable to forward said request to said Web Server; and said Web Server being operable to: obtain information regarding said local network; and tailor a response in view of said information.

### BRIEF DESCRIPTION OF THE DRAWINGS

These and other features of the invention will become more apparent from the following description in which reference is made to the appended drawings in which:

FIG. 1 is a physical layout of an exemplary communication network as known in the prior art;

FIG. 2 is a flow chart of a method for implementing location dependent software applications in a broad embodiment of the invention;

FIG. 3 is a simplified block diagram of a communication network as known in the prior art;

FIG. 4 is a block diagram of a geographic authentication system in an embodiment of the invention;

FIG. 5 is a data flow diagram for a geographic authentication system in an embodiment of the invention;

FIG. 6 is a flow chart of a geographic redirect methodology in a preferred embodiment of the invention; and

FIGS. 7a and 7b are flow charts of a method of geographic authentication in a preferred embodiment of the invention.

### DESCRIPTION OF THE INVENTION

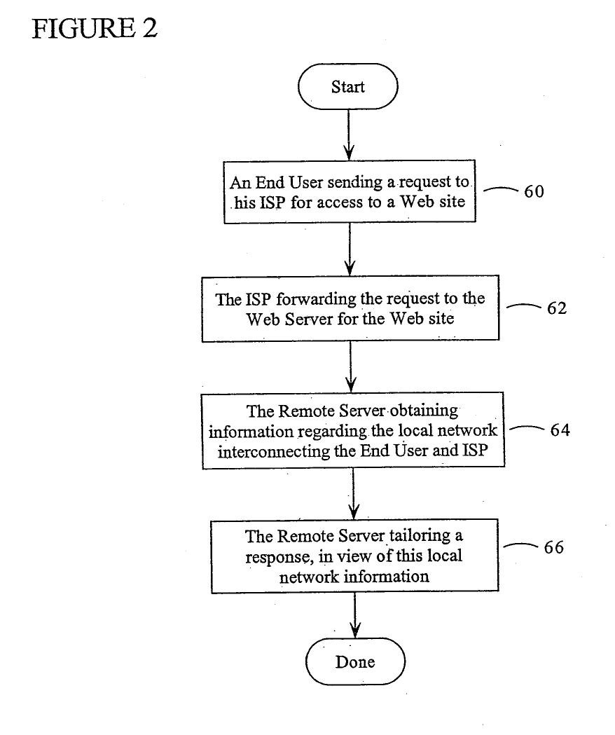

A methodology which addresses the objects outlined above, is presented as a flow chart in FIG. 2. This figure presents a method of communication over a network which is initiated when an End User sends a request to his Internet Service Provider (ISP) to access a Web site at step 60. This communication will be made over the local network interconnecting the End User to his ISP. The ISP forwards this request to the Remote Server which supports the Web site at step 62, by looking at the URL (universal resource locator) in the request.

When this request arrives at the Web Server it first obtains information regarding the local network that the ISP and End User are on at step 64, and then it tailors a response in view of this information at step 66, which it returns to the ISP.

The communication networks may include many networks and media known in the art, and may consist of several different networks working together, including wireless networks such as cellular telephone networks, the public switched telephone network, cable television networks, the Internet, ATM networks, frame relay networks, local area networks (LANs) and wide area networks (WANs).

The End User may send his request to his ISP using a number of different devices including a computer, smart terminal, personal digital assistant, Internet-ready telephone, a dedicated gaming device or other similar interface. Such devices are well known in the art.

The Web site being requested could be similar to one known in the art, and could include content such as text, graphics, audio files, video files, executable applets, data files or attachments such as software files, or other data and files known in the art. The content is not limiting on the invention, and could relate to, for example: games of chance, betting systems, multimedia content requiring high bandwidth such as digital movies or video email, or local advertising content. Additional examples are described hereinafter.

The nature of the information requested by the Web Server, and the manner in which it tailors the response at steps 64 and 66 will depend on the application—what is important from the perspective of the invention is that these steps are done at all. In the art, the ISP and its local network do not interact with transactions between the End User and the Web Server at all, except to pass messages back and forth between them.

The invention requires that some interaction take place, which can easily be implemented effecting some processing at the ISP or its local network. Methods of doing this are described hereinafter. In the preferred embodiment of the invention, this is done using a special server, local to the ISP, which is referred to herein as a Distributed Authentication Server (DAS).

Several exemplary applications include the following:
1. if the End User's request requires high bandwidth, the response may be tailored to provide the content from the DAS server local to the ISP;
2. if the desire is to include local advertising content, the response will indicate that this local advertising content is to be provided; and
3. if the content is subject to local regulatory requirements, as in the case of retail sales taxes or gambling, then the Remote Server will respond to whether the ISP's location has been authenticated.

For example, before allowing an End User to commence legal gambling or betting, the regulators having jurisdiction over the End Users and the casino must be established. Jurisdiction is established by determining the physical locations of the casino, the player and possibly the Remote Server. The location of the casino is known, and the location of the Remote Server is controlled by the casino. What must be specifically determined is the location of the player.

The invention verifies the location of the End User by identifying the location of the Internet Service Provider (ISP), or Internet Access Provider (IAP). While there is a distinction between an ISP and ASP in the art, the distinction is not significant for the purposes of the invention. As the ISP controls the manner in which the End User makes his physical connection to the Internet, he will be in a position to determine whether the End User's physical location can be confirmed sufficiently to allow access. Methods of determining the End User's physical location and methods for communicating the ISP's position are described in greater detail hereinafter.

The high bandwidth and local advertising examples (items 1 and 2 above) are also described in greater detail hereinafter.

The invention of FIG. 2 addresses the problems in the art. It allows businesses and services to target their advertising to End Users on a geographic basis. It also allows regulators to enforce laws and rules regarding controversial content, retail sales taxes and gambling.

No additional hardware is required as in the case of the GPS solutions, and DNS routers do not need to be modified to include location data. Therefore, there is no additional cost to the End User and the invention may be applied without affecting the existing network. As well, the invention is independent of whether IPv4 or IPv6 is being used.

Because the targeting is determined by the location of the ISP and does not require the IP address of the End User, the invention operates with Dynamic Host Configuration Protocol (DHCP) systems. This also allows the targeting to be performed without actually identifying the End User, maintaining his privacy. As well, because the determination of location is made by the ISP, there is no opportunity for the End User to tamper with the verification process.

More detailed aspects of the preferred embodiments of the invention will now be described.

Geographic Authentication System

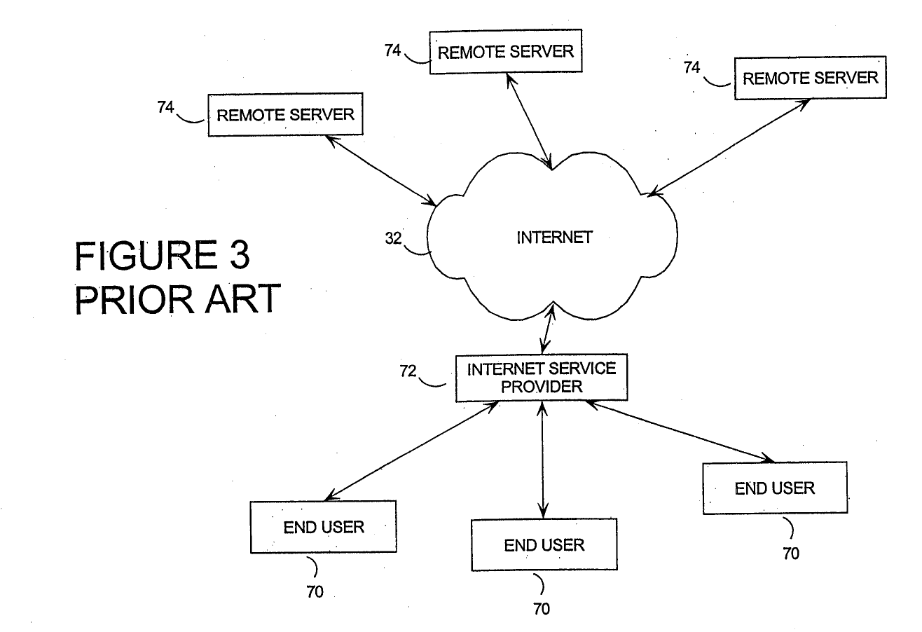

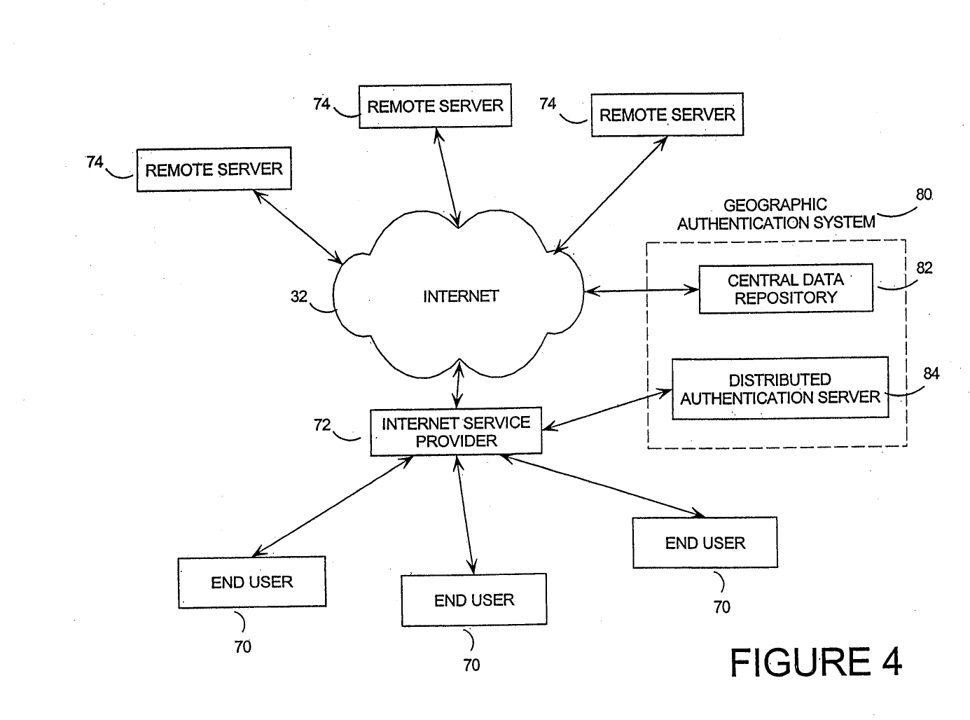

A simplified representation of the Internet is given in the block diagram of FIG. 3. This prior art system provides a good basis against which the embodiment of the invention presented in FIG. 4, can be compared.

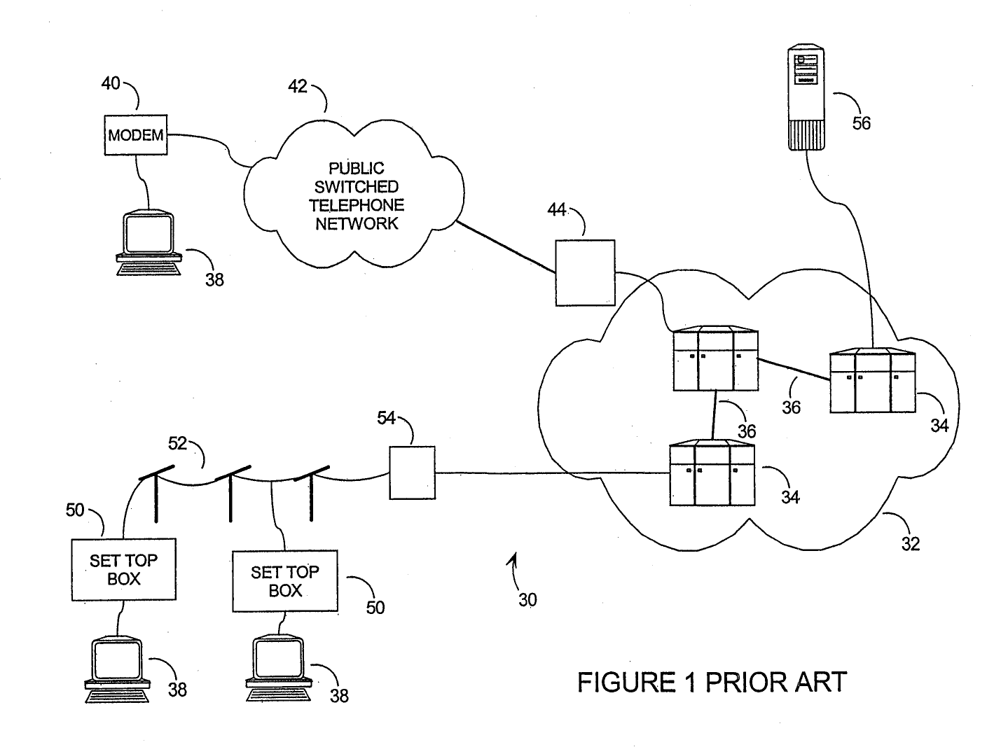

In FIG. 3, a number of End Users 70 are presented, who have access to the Internet 32 via their Internet Service Provider (ISP) 72. The End Users 70 may employ computers 38 as in FIG. 1, or other interface devices as known in the art, and as will emerge as technology evolves. These End Users 70 may access their ISP 72 in different ways, such as via cable modem, telephone line mode, or wireless methods, which is not limited by the invention. Via the Internet 32, the End Users 70 then have access to various remote servers 74, who provide them with software code and data content.

In an embodiment of the invention, a Geographic Authentication System (GAS) 80 provides an infrastructure for effecting the new functionality. As shown in FIG. 4, the GAS consists of two major components: a Central Data Repository (CDR) 82 and one or more Distributed Authentication Servers (DAS) 84.

ISPs 72 subscribing to the GAS service can obtain a DAS 84 from the GAS provider. The DAS 84 is a standalone computer or server pre-configured with the DAS software application, which will generally be installed with the ISP's other servers and equipment, and on their LAN (local area network) or MAN (metropolitan area network). Since each ISP 72 will generally have its own DAS 84, one CDR 82 will generally serve multiple DASs 84. As well, ISPs serving large areas with multiple LANs may require multiple DAS machines.

When first booted, the DAS 84 asks the ISP 72 for some simple configuration information. This information may include, for example: telephone area code, City, State/Province, Postal/Zip Code and country.

Once the DAS 84 has been configured it uses existing software algorithms to discover configuration information regarding the local LAN and to identify paths to the CDR 82. Once this information has been gathered it is sent to the CDR 82. The CDR 82 performs an address lookup on the ISP 72 and stores the ISP address as well as the serving location.

For authentication services the DAS 84 can receive commands from the CDR 82 requesting the validation of an End User 70. On such requests the DAS 84 will verify that the End User 70 is connected to the same LAN as the DAS 84.

The CDR 82 provides a single point of access for authentication services. All geographically aware applications communicate directly to the CDR 82. The CDR 82 may complete the authentication locally or refer it to a specific DAS 84.

To assure acceptance of the services offered by the GAS system 80 the designers and implementers must recognize that personal anonymity is one of the sacred trusts of the WWW. The final system should provide authentication not identification. Preferably, it will be impossible for any party to use the authentication service as a means of identifying an individual End User.

The preferred embodiment of the invention consists of a combination of hardware and software, distributed throughout the WWW. The distributed systems should be tamper proof, and communications to and from the distributed servers should be secure. All servers must continually verify that local content has not been compromised. Software and systems for effecting these goals are well known in the art.

The completed system should also include a comprehensive set of utilities simplifying and automating the day to day operations of the system.

All processing of money is preferably accomplished via a known e-banking partner. If possible, End Users 70 should be provided an opportunity to choose which e-banking partner they wish to use for payment.

The two main applications of the invention that have been evaluated herein are:
1. server requests location authentication for a known service provider; and
2. automatic re-direct to closest server from a known service provider.
   This list is not definitive and additional applications would be clear to one skilled in the art. These two particular applications are described hereinafter.

Although the communications between the GAS 80 and the rest of its environment will vary with the services being performed, the following general description will aid the reader in appreciating the flexibility and power of the GAS 80. The description will also aid in the understanding of the two particular applications described hereinafter.

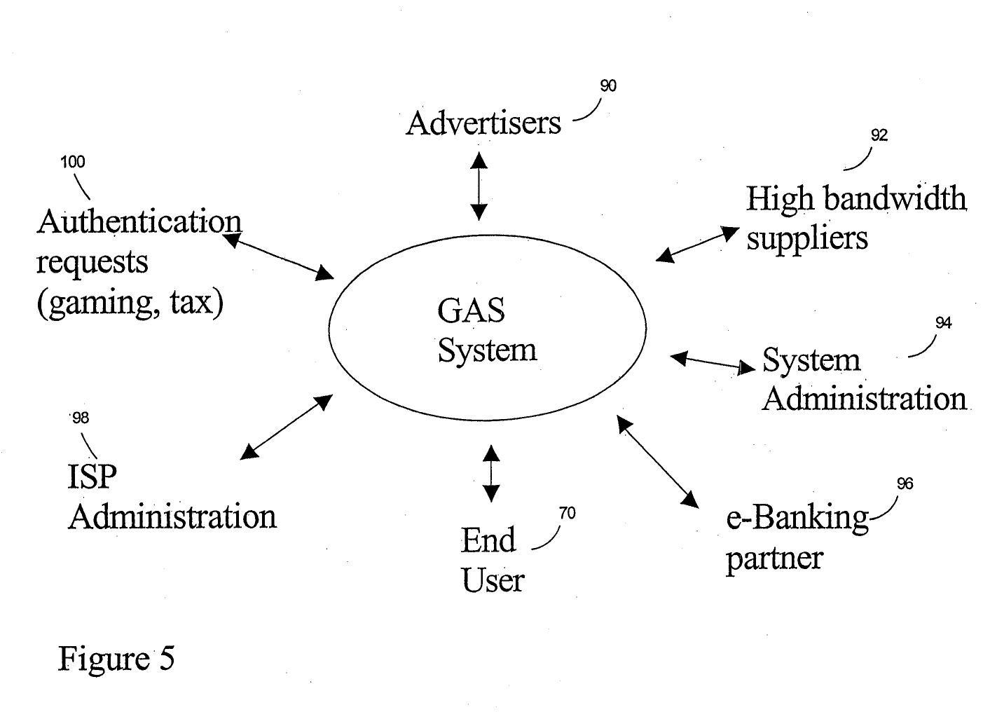

FIG. 5 presents such communications in the form of a block diagram.

Advertisers 90, for example, may use the GAS 80 to direct advertising on a geographical basis, or to provide an advertising content search engine which is capable of geographic or keyword searches. The GAS 80 may also provide detailed statistics to the Advertisers 90 including: number of impressions, number of key clicks on an impression and number of concurrent End Users 70 in a given geographic area.

This enables Advertisers 90 to provide new services and differentiators including online contests with random prizes and various forms of payment.

High Bandwidth Suppliers 92 may interact with the GAS 80 by providing data content in exchange for electronic payments, and receiving various data such as End User usage statistics. Other communications will also generally take place, such as communication of:
1. the supplier's distribution criteria;
2. financial reconciliation data;
3. confirmations from End Users 70 to accept Content from the High Bandwidth Supplier 92; and
4. redirections to electronic commerce partners to administer download charges.

Other features follow logically from these, such as providing Suppliers and End Users with Selective Download capability based on geographic location, automatically generating content maps for each geographic area, and updating Suppliers with End User download usage.

The System Administrator 94 of the GAS 80 will communicate with the core, by receiving such data as database usage, throughput, client usage, advertising, gaming usage, cash usage, and backups. The System Administrator 94 will support the GAS 80 by providing data from a maintenance database, providing usage reports and making cash adjustments to the various accounts.

Electronic banking (e-Banking) services 96 can interact with the GAS 80 as partners, handling monetary issues for the GAS 80 (general the supply of advertising and high bandwidth downloading services will initiate cash transactions). In such a case, electronic sales receipts and configurations will pass in one direction, while electronic cash will flow in the other.

The GAS 80 can also be used as a platform for offering e-Banking services as it provides the ability to authenticate End Users 70, provide geographic advertisements, re-direct End Users to local services and provide high bandwidth downloading. The GAS 80 of course, can allow End Users 70 to select from a list of e-Banking services.

End Users 70 will interact with the GAS 80 in many ways, depending on the services that they are requesting. Typically, initial configuration data will be provided by the End User 70, followed by requests for data downloads, advertising information or gaming services. Depending on the nature of the request, other data may also be transferred such as advertising search criteria and high bandwidth download requests. In response, the GAS 80 will provide the requested data content and interrelated monetary interaction.

The invention is independent of whether the End User 70 subscribes to GAS services on the basis of time period, pay for use, or other models known in the art.

In general, the ISP Administration 98 will interact with the GAS 80 by transmitting configuration data to it, and receiving electronic cash. Usage statistics may also flow between the ISP Administration 98 and the GAS 80.

In the case of the high bandwidth download feature, the ISP will have local server hardware which makes up part of the GAS 80 and is configured by it, in real time. As described with respect to FIG. Q, content requests will flow to the GAS 80 and URL redirects flow back to the ISP's local server, to effect the high bandwidth downloads or geographic advertising.

Authentication Requests 100 may be sent to the GAS 80 from any remote server. The communications between the requester and the GAS 80 can be minimal, for example, requesting a geographic authentication, and receiving either a confirmation or denial. These communications will generally be made in a secure manner.

The specific details of several embodiments of the invention are now described.

1.0 Geographic Redirect

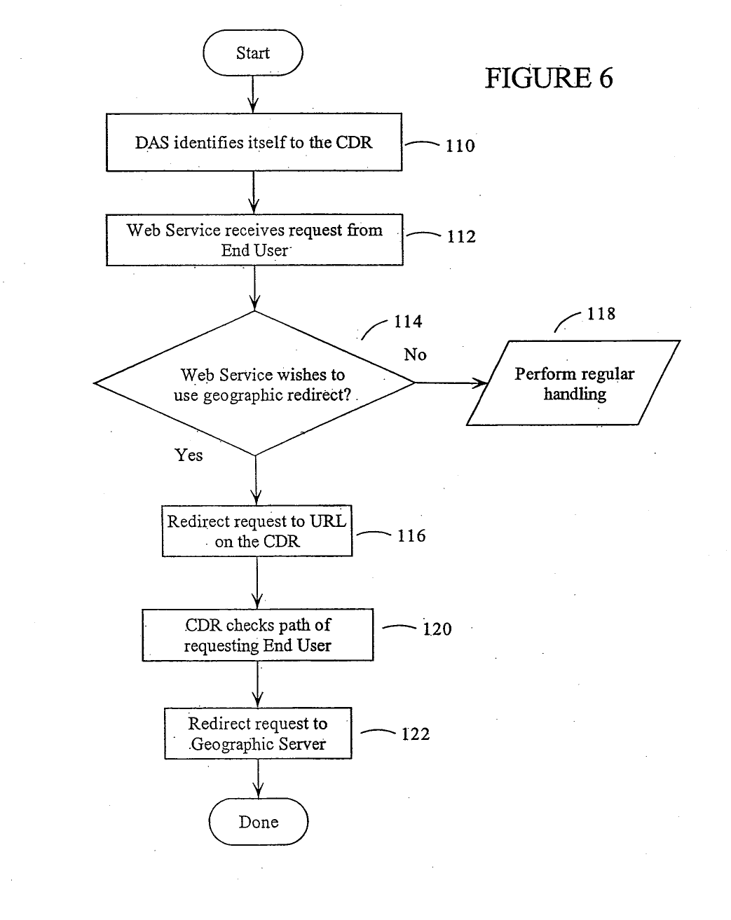

The geographic redirect technology of the invention makes use of the two tier architecture of the GAS system 80; one tier being directly connected to the Internet 32 (the CDR 82), and the other residing on the ISP's LAN or MAN (the DAS 84). A brief description of this process is presented in the flow chart of FIG. 6.

Firstly, as noted above, each DAS system 84 identifies itself to the CDR 82 at startup, providing the CDR 82 with local network configuration information. This is presented as step 110 in FIG. 6.

Now, when a Web Service receives a request from an End User at step 112, which it determines can be handled using the geographic redirect technology at step 114, it may redirect the End User's request to a service specific URL on the CDR 82 (per step 116). If it is determined at step 114 that the request is most effectively handled in the regular manner, then this processing can be effected at step 118.

When the CDR 82 receives a request for a Geographic Redirect URL the CDR 82 checks the path of the requesting End User at step 120, and redirects the End User's request to the URL of the closest Geographic Redirect server (such as a DAS server 84). The subscribing service provider will generally provide server locations and/or area identification for the geographically distributed servers.

In the preferred embodiment of the invention, the geographically distributed servers will be DAS servers 84, but this is not critical. For example, the URL redirection can send the End User's request:
1. to a different server within the relevant geographic area;
2. to a different server adding an area tag to the contact URL; or
3. it can process the End User's request internally (i.e. at the CDR 82) with knowledge of the End User's geographic location.

This embodiment of the invention allows advertisements and other content to be directed geographically, which makes such advertising far more effective and should address the cost issues which presently hinder growth of the Internet.

No additional End User hardware is required as in the case of the GPS solutions, and DNS routers do not need to be modified to include location data. As well, the invention is independent of whether IPv4 or IPv6 is being used. While there is a cost to the ISP, they can recover this cost with the new services the invention provides.

This geographic redirect technology may be embodied in the services described in the two following sections: 1.1 Local Advertising, and 1.2 High Bandwidth Data Distribution. Many other applications would be clear to one skilled in the art from the teachings herein.

1.1 Local Advertising

As noted above, advertising on the Internet today typically is not done with consideration for the actual geographic location of the End User 70. The same advertisements are presented to any End User 70 who accesses a given Web page, regardless of who they are or where they are. Obviously, this approach is not efficient, as some viewers will not be in the geographic marketing area of the advertiser, which may be limited to a continent, country or region. Therefore, this method of advertising has questionable commercial value.

Some Web sites monitor the preferences of End Users 70 accessing their Web sites, and record those specifics. However, the creation of user preference databases are generally considered by the public to be an invasion of privacy, so there is pressure to create laws or apply existing laws to prevent such monitoring. Such monitoring has also encouraged the development of anonymous servers, which serve as intermediaries to disguise End Users from the Web sites they wish to access.

Thus, the Local Advertising service of the invention relies on two premises:
1. that End Users 70 want access to local advertising content that is pertinent to their needs, but maintains their privacy; and
2. that Advertisers 90 want low cost marketing directed at local customers in a timely fashion.
   The geographic redirect invention can be used to satisfy these requirements, by directing End User 70 requests to servers having the desired local content. This can be implemented in a passive manner (in that the End User 70 is not particularly aware or involved in the decision to provide local advertising content), or in an active manner.
   1.1.1 Active Local Advertising

In the active embodiment of the Local Advertising System (LAS), End Users 70 direct their Internet browser window to a URL on the CDR 82 which implements the LAS system (i.e. the LAS runs as a service on the CDR 82). The End User 70 fills out a form specifying the types of advertising information they are interested in and an update frequency for display of appropriate information. The search types are free format allowing the End User 70 complete freedom in finding the types of promotion of interest to them.

Once the search criteria has been entered, the browser window launches a second window which displays advertising content based on the End User's geographic location and keyword search. The advertisement content is updated at the polling frequency defined by the End User 70.

Advertisers 90 access the LAS and create advertisement content using provided graphical edit tools. The advertisement creation tools allow the advertiser 90 to enter start and end dates of the promotion and keywords which describe the product. Payment for advertisement placement is done online through one of the CDR e-banking partners 96.

The Local Advertising System (LAS) also allows the Advertiser 90 to offer special promotions or contests, for example, offering a random prize to every 1,000th impression, or offering an entitlement to an End User 70 clicking on an impression within a certain time limit. In cases where an End User 70 qualifies for a special promotion or entitlement the LAS system could provide the End User 70 with a unique code which can be used at the vendor site for promotion verification.

Advertisers 90 may also have access to statistical information from the GAS 80 including:
current number of End Users 70 accessing the advertising system in a given geographic area;
number of impressions sent to End Users 70; and
number of impressions selected (clicked) by End Users 70.
   Advertisers 90 could also be provided with a list of the top keywords End Users 70 are searching for and provide End Users 70 with the top keywords that Advertisers 90 are sending out.

In an ideal implementation of LAS, the CDR system off-loads advertising content to the geographically distributed DAS systems. The End Users 70 access the CDR 82 and are automatically redirected to the LAS service at the closest DAS 84. The DAS servers 84 reply to the client advertising polls with appropriate advertising material and also return appropriate statistical information to the CDR 82.

For market trial purposes or very small implementations, the entire LAS could be implemented in the CDR 82.

1.1.2 Passive Local Advertising

The invention may also be used to provide location-targeted advertising without the active participation of the End User 70.

The Web Service coordinates this process by responding to an End User's request in two ways:
1. by returning the content that the End User 70 had requested; and also
2. by initiating a URL redirect in the manner of steps 116, 120 and 122 of FIG. 6. This separate request will result in location-targeted advertising being sent from the Geographic Server to the End User 70.
   Thus, the End User 70 receives two responses to his request: the content he had requested from the Web Service, and location-targeted advertising from the Geographic Server.

The nature of the content requested by the End User 70 does not limit the invention, and could include text, graphics, audio files, executable applets, data files or attachments such as software files, or other data and files known in the art.

Rather than location-targeted advertising, the invention could also be used to distribute other information of regional interest including road maps, weather reports, local news and announcements, stock quotations, notices of public meetings and the like. Of course, the location-targeted advertising would generally be tailored to the language that is dominant in the region, or could be selected from a number of choices to correspond with the language used in the regular content the End User 70 had requested.

1.2 High Bandwidth Data Distribution

The distributed architecture of the GAS system 80 can be used to provide a highly effective method for High Bandwidth Data Distribution. In the preferred embodiment, every participating ISP 72 has at least one DAS server 84 located on the LAN/MAN side of their network. Data transmitted from a DAS 84 to an ISP's End User 70 enjoys the speed of the local LAN/MAN and does not suffer from network induced congestion and bottle necks that the rest of the Internet and Remote Servers may suffer from.

The High Bandwidth Data Distribution Application allows High Bandwidth content suppliers to download content to the CDR 82. Once the data has been accepted at the CDR 82 the content supplier indicates which geographic areas are licensed for the content and the CDR 82 automatically distributes the content to the appropriate DAS servers 84.

Both the CDR 82 and the DAS servers 84 produce automated content browsers which allow End Users 70 access to the content. The CDR 82 can redirect the End User 70 to the DAS 84 for browsing or allow browsing on the CDR 82 and redirect the End User 70 to the DAS 84 for downloading.

Thus, the process presented in FIG. 6 and described hereinabove can be used to distribute high bandwidth content. The only caveat for this application is that the high bandwidth content be stored as close as possible to the End User 70 rather than on the Remote Server 74. Consequently, when an End User 70 requests content from the CDR 82 or directly from the DAS 84, the data is transmitted to the End User 70 at the ISP's highest available internal bandwidth.

This service benefits the ISP 72 in several ways:
1. It allows the ISP 72 to delay costly upgrades to Internet access facilities: ISPs 72 make their money by multiplexing as many End Users 70 as possible onto limited bandwidth Internet access pipes (ramps). Slow data rates, when accessing the WWW, are rarely due to internal ISP communication problems but rather due to the fact that many End Users 70 are trying to access the limited ‘Internet ramp’ of their ISP 72 concurrently.
As high bandwidth content usage increases, every ISP 72 will be forced to increase the bandwidth of their Internet access facilities. Current caching systems improve response for low volume, small footprint, non-dynamic applications but they can never be expected to maintain multi-gigabytes of high definition movies or audio content. The DAS 84 is specifically designed to store large multi-gigabyte files and to transmit them directly to locally connected End Users 70. This, of course, frees up existing Internet access bandwidth for End Users 70 who are legitimately browsing the WWW.
2. It provides a new model for revenue generation: with this technology ISPs 72 become content distributors for high volume, value added, multi-media content suppliers. The traditional supplier/distributor business model includes volume based distribution fees paid by the supplier to the distributor. This represents a vary good marriage between old and new business paradigms which has tremendous validity on the WWW.

The High Bandwidth Data Distribution embodiment of the invention could easily be implemented with the following functionality:
to include a complete set of tracking statistics for the ISP, distributor, and the content supplier;
to redirect End Users 70 to appropriate e-banking partners for payment, as required
;to distribute content based on any demographic of interest, for example, distributing Foreign or cultural content to a particular local community; and
the process can operate in a fully connected mode providing an ideal architecture for new anti-piracy processes.
   2.0 Authentication Server

Another application which exploits the distributed architecture of the invention is the Authentication Server (AS), which provides any Internet based application with the ability to authenticate an End User's location. Validated End User location is desirable for many applications including implementing gaming systems and enforcing sales taxes.

The AS is a secure, high volume, high availability, on-line transaction, processing-based software application, preferably running in the CDR 82. Remote software applications and Web Services access the AS through a published IP address and PORT number using the AS interface specification. The AS authentication interface is purely robotic, so no user interface is provided, though an End User interface is provided for accounting set up and verification. The AS customers are typically Application Service Providers (ASP) or individual WWW application support organizations.

The interface protocol used by this application is the connection-less socket protocol UDP (user datagram protocol). For authentication and security, the AS only serves requests from IP addresses which are known to belong to the requesting Web Service.

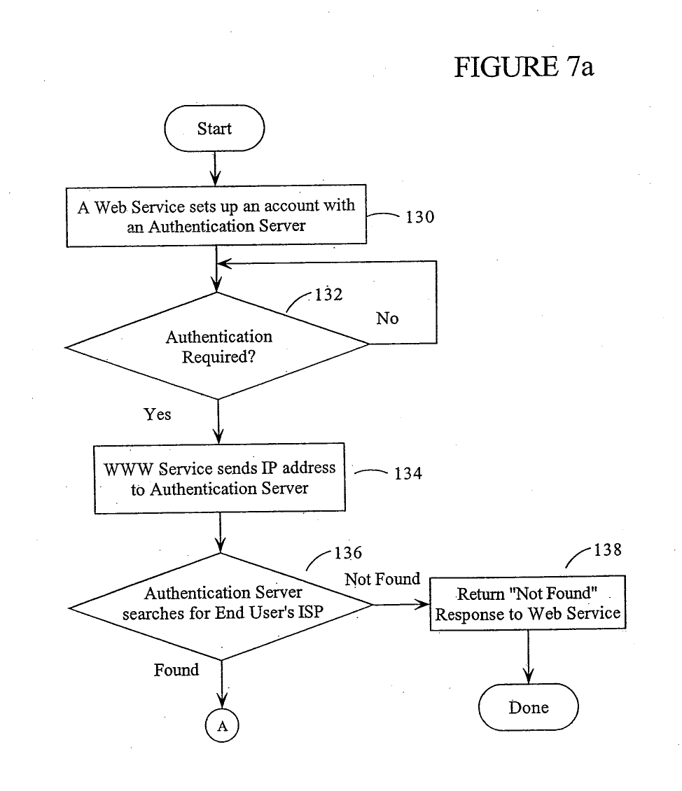

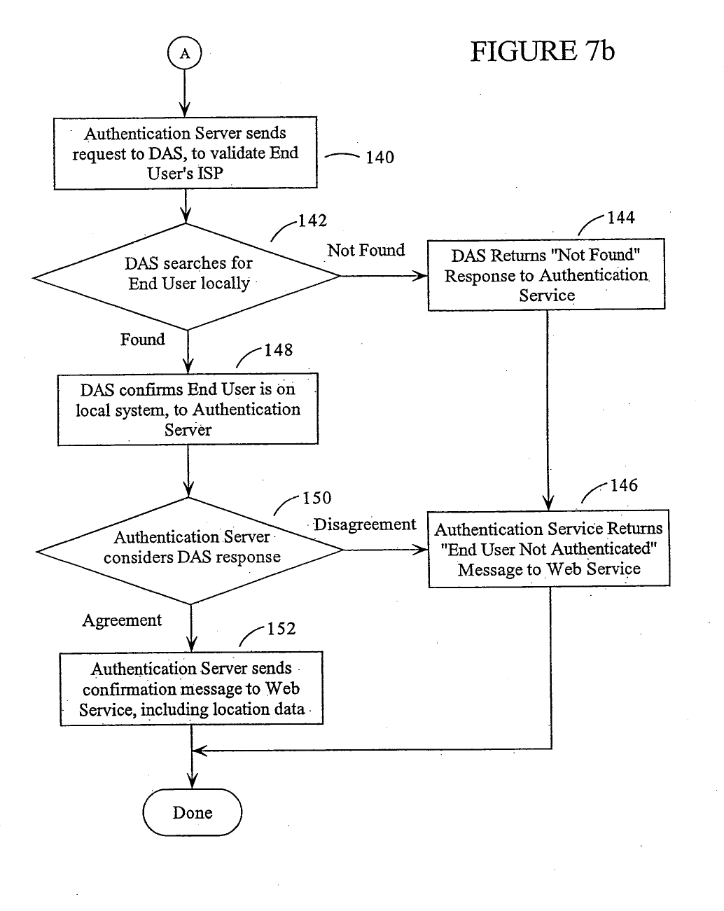

The AS process generally proceeds as presented in the flow chart of FIGS. 7a and 7b. Firstly, at step 130, a Web Service requiring access to the AS contact the AS web site, sets up an account and agrees on remuneration. The Web Service may pay for the AS service in a number of ways including on a time basis (such as monthly), based on the raw number of authentication requests or number of authentication hits.

Authentication hits represent the number of times the AS server finds queried IP addresses to be authenticated and returns the IP location to the Web Service. This type of payment model may be necessary during product roll out as the AS may not have sufficient information to process all IP authentication requests and may return a large number of “IP unknown” responses to the requesting Web Service.

Once the Web Service has established an account with the AS, the Web Service implements the AS interface specification using the provided integration kit. When a session becomes active (identified as such at step 132), the Web Service uses the AS interface to pass the End User's IP address to be validated to the AS at step 134.

The AS checks its local tables for the End User's ISP 72 at step 136 and if it is not found, then the AS returns a “not found” message to the Web Service at step 138, and the routine is completed. The local tables could be compiled in a number of ways, including the following:
the GAS 80 locates all IP addresses on its span;
the GAS 80 sends all IP addresses plus identification of the corresponding ISP 72 to a Central Server; and
the Central Server publishes specification for validation interface.
   Whereby any service requiring End User location information, simply requests validation from the Central Server by providing the End User IP address.

If the End User's ISP 72 is found at step 136, the AS sends a request to the DAS 84 associated with the ISP 72 at step 140 of FIG. 7b asking it to revalidate the presence of the End User 70 on the ISP 72. This is done to verify that End Users 70 are not spoofing their location or routing their communications through an anonymous server.

In response to this request, the DAS 84 determines at step 142 whether the End User 70 is served by the identified ISP 72. If the End User 70 is not served by the identified ISP 72, then control passes to step 144 where the DAS 84 returns a “Not Found” message to the AS. In turn, the AS then sends a message to the Web Service at step 146 advising that the End User has not been authenticated.

If the DAS 84 determines at step 142 that the End User 70 is served by the identified ISP 72, then it sends a positive message to that effect, to the AS at step 148. The AS then compares its results with the location results from the DAS 84 at step 150. If the data are in agreement, then the AS sends a positive confirmation message to the Web Service at step 152, along with the city, state/province, country, telephone area code to the requesting service.

If the AS determines at step 150 that the location results from the DAS 84 do not agree with its records, it sends the message to the Web Service at step 146 that the End User has not been authenticated. The routine is then complete.

The flow charts used to describe the various embodiments of the invention are only intended to be representative of the general process flow, and would be altered for different implementations. The flow chart of FIGS. 7a and 7b, for example, is presented with a discrete beginning and end, but can be implemented in many other ways, for example: as various subroutines residing on different computers and servers, as separate pieces of software code and Java applets, in object-oriented form, etc.

2.1 Online Gaming and Gambling

As noted above, there are a number of services which are well suited to online implementations, except that it is very difficult to regulate them in the online environment. Online gaming and gambling is just one example.

The AS embodiment of the invention allows a Web Service to verify the geographic location of the End User 70. This allows them to determine whether the End User 70 is in a geographic location which they are legally allowed to serve. Once this determination has been made, they can allow the End User 70 access to their services for the duration of the session.

Generally, the Gaming Server will also require End Users 70 to establish accounts or register in some manner, so that the End User's identity can be verified when he logs on. The registration and verification can be done using existing technologies.

The play of the games and settling of accounts may also be done in manners known in the art. However, Gaming Servers could also use the e-banking partners 96, taking advantage of the security the invention offers between the GAS 80 and the e-banking partners 96.

It would also be clear to one skilled in the art that the invention may be applied to many amusement games, games of chance, for betting or entertainment purposes, including without limitation: video lottery terminals, keno, roulette, dice games such as craps, ma jong, jai lai, pai gow, horse racing, dog racing, lotteries, slot machines, baseball, football, golf, basketball, fantasy sports leagues and fantasy sports games, and card games which may include poker, black jack, solitaire, and baccarat. The invention may, for example, be used to collect participants in different geographical areas to compete against one another as teams.

Thus, the invention allows twenty-four hour a day, seven day a week gaming and amusement services without the inconvenience of having to attend a physical location. As well, regulators' requirements can easily be accommodated. The invention offers many other advantages, which would be clear to one skilled in the art. For example, it allows organizations using casinos to launder money, to easily be identified and monitored.

2.2 General Applications of the Authentication Server

End User Authentication in the manner of the invention could also be used for far more than simply gaming and betting, in fact any services which a Web site wishes to restrict to End Users in a certain geographic area may be so restricted. As noted above, these services may include for example: government publications, help lines or counselling services. The system could also determine which state and national taxes apply to the sale of goods by determining the location of the buyer and seller.

Large parts manufacturers in the automotive and aerospace industries could use the invention to route parts to distributors on a geographic basis, or for added security. The large automobile manufacturers intend to implement an online parts distribution system in which different types of customers have different levels of access. The invention could be applied to such a scenario, for large or small parts, by verifying the location and integrity of the source and customer requesting the parts.

Other applications include, for example:
1. Correlating web page accesses with geographic areas allows valuable marketing and statistical data to be easily collected.
2. The distribution of movies can be better controlled to increase their viewing rates. Rather than making a complete collection of movies available to all users at one time, in which case End Users will only view the best ones, the method of the invention can be used to roll out certain movies in certain areas, at certain times. A movie distributor could, for example, roll out ten new movies each month, encouraging users to fall into a pattern of viewing new movies as they are released. The controlled release makes it easier to market the movies. By rolling out movies in different regions at different times, public interest and anticipation can be built, increasing demand.
The same technique can be used for other electronic content or on-line applications such as music and video games.
3. A movie distributor could also avoid making certain movies available in certain areas, to manage public image. For example, a producer of family movies may be concerned that releasing a risque movie in a religious region may damage their reputation, while it might be overlooked in another area. With the invention, the movie distributor could release the movie in some regions and block it in others.
4. The invention could be used to enforce publication bans in court cases.
5. The invention allows entertainment content to be distributed far more efficiently to smaller markets. Currently, movies are only produced if they have very broad appeal. The invention would allow a documentary to be produced on the Walkerton water treatment scandal, for example, and be marketed and distributed in the area that has an interest in the product, rather than nationwide or internationally. Web portals in the region of interest could be provided with the marketing material, while web page requests from users outside the targeted jurisdiction would receive marketing content appropriate to their own area.
6. Like gaming, censorship is also generally regulated by geopolitical region. The invention would allow censorship of video, text, audio and audio/visual content by correlating the End User's location with a censorship database or flags within the web pages providing the content.
Some measure of protection would be required to prevent End Users from downloading content inside an area in which certain content is allowed, and re-distributing it into an area in which it is censored. Such techniques are known in the art.
7. Language laws may be enforced using the invention. If for example, a particular province or state requires business to be carried out in a particular language, then the invention can identify requests coming from users in that state and only return web pages that comply with those language requirements.
Similarly, the invention may be used to identify the default language for the End User. For example, it may be assumed that all users in United States will be able to read English, so English web pages would be returned to users in the United States by default.
8. Prices for electronic commerce (e-commerce) products and services can be presented to users in their local currency, using local prices sheets, and taking into account shipping and/or handling costs to reach that locale.
9. Encryption software is also controlled by geopolitical regions. The United States, for example, does not allow export of certain strong encryption software in an effort to prevent foreign organized crime from obtaining access to secure communication. The method of the invention could be used to enforce such laws.
10. Marketing can be regionalised. For example, electronic sales flyers and brochures may be targeted on a geographic basis, so that they include prices and products which vary from region to region.
11. The invention allows marketing techniques which communicate a higher level of “trust” than traditional Internet marketing techniques. For example, the web page of a large bank may be tailored for each branch, on a geographic basis, so that End Users believe they are communicating with the local bank, rather than a nation-wide server.
12. Sports content can be tailored by geographic region. For example, hockey may be assumed to have higher priority in Canada, and baseball, a higher priority in United States. If a small-town fastball team is playing in the state finals, it may be assumed that this will be of interest to users in the small town but not to users in other states. Thus, web portals, menus and web pages in general may be tailored for regional content using the invention.

On-line software applications and operating systems could tailor functionality based on location, using a number of the concepts outlined above. Parameters of an on-line operating system that could be modified by geographic location could include: encryption techniques (see item 9 above), language (see item 7), advertising and marketing materials, and identification of national and state holidays in a calendar application. Default spelling of words could also be determined by geographical location. The word “colour”, for example, is typically spelled “color” in United States and “colour” in Canada.

In the preferred embodiment of the location dependent processing applications, all Internet communications are to be encrypted as a security precaution, using one of many techniques known in the art. Currently, the preferred method is that of public-key/private-key encryption. Encryption preserves the privacy of the transactions, prevents tampering with the game or results, and protects against unauthorized access to a player's financial accounts.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

The invention could, for example, be applied to computers, smart terminals, personal digital assistants and Internet-ready telephones. Again, such implementations would be clear to one skilled in the art, and do not take away from the invention.

What is claimed is:

1. A method of content distribution over a communication network comprising:
an End User sending electronically over a local network of the communication network a request containing a Uniform Resource Locator (URL) to an Internet Service Provider (ISP) to access content from a Web site;
said ISP forwarding said request to a Web Server maintaining said Web site; and
said Web Server automatically:
obtaining information regarding said local network,
verifying that said End User is connected to said local network,
tailoring a response in view of said information regarding said local network, and
directing the URL of said request to a URL on said local network.

2. The method as claimed in claim 1, wherein said local network comprises a local area network (LAN) or metropolitan area network (MAN).

3. The method as claimed in claim 1, wherein each communication is encrypted.

4. The method as claimed in claim 1, further comprising the step of sending an account name and password.

5. A communication system comprising:
an End User;
an Internet Service Provider (ISP);
a Web Server;
a local network, interconnecting said End User and said ISP; and
an Internet network, interconnecting said Web Server and said ISP;
said End User being operable to send electronically a request containing a Uniform Resource Locator (URL) to said ISP to access content from a Web site on said Web Server;
said ISP being operable to forward said request to said Web Server; and
said Web Server being operable to automatically:
obtain information regarding said local network,
verify that said End User is connected to said local network,
tailor a response in view of said information regarding said local network, and
direct the URL of said request to a URL on said local network.

6. The communication system of claim 5, further comprising:
a Central Data Repository;
said Central Data Repository being connected to said Internet network and being operable to store and serve data content to said End User; and
said Web Server being operable to redirect requests from said End User, to said Central Data Repository.

7. The communication system of claim 5, wherein:
said Web Server comprises a Movie Distribution Web server having a Movie Distribution Web site;
said End User is operable to send a movie request to an Internet Service Provider (ISP) to access a movie from said Movie Distribution Web server;
said ISP is operable to forward said movie request to said Movie Distribution Web server; and
said Movie Distribution Web server is operable to respond to authentication of said ISP by allowing said ISP to transmit a locally cached copy of said movie to said End User.

8. The communication system of claim 5, further comprising:
a Distributed Authentication Server;
said Distributed Authentication Server being connected to said local network and being operable to confirm that said End User is connected to, and is local to said local network.

9. The communication system of claim 8, wherein:
said Distributed Authentication Server is operable to store and serve data content to said End User; and
said Web Server is operable to redirect requests from said End User, to said Distributed Authentication Server.

10. A computer readable memory medium for storing software code executable to perform the method comprising:
an End User sending electronically a request containing a Uniform Resource Locator (URL) to an Internet Service Provider (ISP) to access content from a Web site, via a local network interconnecting said End User to said ISP;
said ISP forwarding said request to a Web Server maintaining said Web site; and said Web Server automatically:
obtaining information regarding said local network,
verifying that said End User is connected to said local network,
tailoring a response in view of said information regarding said local network, and
directing the URL of said request to a URL on said local network.
